(19) United States
(12) Patent Application Publication
(10) Pub. No.: US 2005/0273500 A1
(43) Pub. Date: Dec. 8, 2005

(54) Apparatus and method for controlling remote carrier

(76) Inventor: I-Hsuan Shao, Taipei (TW)

Correspondence Address: BIRCH STEWART KOLASCH & BIRCH, PO BOX 747, FALLS CHURCH, VA, 22040-0747, US

(21) Appl. No.: 10/921,889

(22) Filed: Aug. 20, 2004

(30) Foreign Application Priority Data
May 11, 2004 (TW) 093113145

(51) Int. Cl. G06F 15/16

(52) U.S. Cl. 709/217

(57) ABSTRACT

An apparatus and method for controlling remote carriers includes a control end and a carrier. A wireless network or wireless communication network or both is established as a fast channel to transmit control signals and monitor signals between the control end and the carrier. Signals are transmitted in an instant and interactive fashion. The invention provides a greater expandability and overcomes the distance barrier between the control end and the carrier.

### BACKGROUND OF THE INVENTION

1. Field of the Invention

The present invention relates to an apparatus and method for controlling a remote carrier or carriers that uses a wireless network, a wireless communication network, a telecommunication network; as well as employing one or more integrated processors to control and monitor the carrier, and/or retrieve their real-time status.

2. Background of the Related Art

The old boundaries that divided communication, information, media and entertainment have vanished. These services have now been integrated. In any environment covered by telecommunication, and accessible by mobile devices, we can connect any two or more telematic objects. The fixed services today will become mobile services in the future.

In the mobile service environment, users can watch and listen to video or audio, transfer information, send or receive e-mail and digital messages, or play interactive games with friends. Basically, any dual-way transfer of real-time data and information transfer are possible. 3G mobile communications not only aims to transmit information and data at high speed, it also has to take into account user convenience and high-speed data access.

The core technology of 3G mobile networks is a packet Internet Protocol (IP) to maintain constant online connection. Hence, data and information can be immediately downloaded to a user's telematic device. The constant connection is a minimal expense. The market suggests applications of wireless communication and connection will continue to grow. Interaction requirements between consumers and mobile devices or between machines and machines, or any other interaction between human user, mobile device and/or machine will continue to grow.

The present methods for controlling remote objects such as remote controls, TV, machines, airplanes and toys mostly are transmitted through a remote controller via antenna cable (Radio Frequency), or infrared light. Refer to FIG. 1 for a conventional remote control method. A control end 10′ is provided to control a carrier 20′ by sending out a control instruction to a control chip or microprocessor of the carrier 20.′ This will control an electric motor, or a non-electric engine, that drives the carrier and operation of a direction switch device of the carrier. The control method of the carrier that uses electric driving generally has a control section with power supply to activate a DC motor. When the mechanical device is on standby, the motor activating circuit is not connected to the power supply. When the external environment issues an activation command such as forward, backward, left or right, the receiving device of the carrier receives the instruction and magnetizes a relay. A DC voltage is then sent to the electronic circuit to activate the DC motor to a switch sensor. The power supply generated by fuel, charges batteries and transforms the power to the appropriate power receiver of attached electronic devices. This will then supply the electronic signal to other sensor circuits and the main control circuit. Other vehicle devices such as display lights, altimeters, trip recorder (or black box) etc. Moreover, the control chip of the main control section provides control signals, required by the motor, for moving through I/O ports, sensors and Portable Inertial Navigation System (PINS). These motions include all three-dimensional movements. The sensors record the movements of the vehicle. The number of the sensors depends on the accuracy required, such as three, four, five or more. The activating switch receives commands from the microprocessor to control the motor to enable the mechanical means to respond accurately and rapidly. According to the commands of the sensors, the carrier will then move in any direction.

Due to distance and signal limitations, the conventional remote control method set forth above is limited to host-slave method for control. Conventional method can only transmit command signals from control end to carrier end. And due to the limitations of host-slave method, communication from carrier back to the control end is generally not available. Hence control could be excessive or inadequate. In addition, the conventional operation usually uses a remote controller as the control end. The conventional controller does not have enough function keys. Therefore to develop a novel apparatus and method to solve these shortcomings, these new methods will speed up control command transmissions and modify control signals. This is the goal of the present invention.

### SUMMARY OF THE INVENTION

The primary object of the invention is to provide an apparatus and method for controlling remote carrier through the Internet or a mobile communication transmission approach. The wireless network such as 802.11 g has maximum transmission speed of 54 Mbps, thus can increase the transmission speed of control commands and does not have control distance limitation by network integration.

Another object of the invention is to provide an apparatus and method for controlling remote carrier through a wireless communication transmission approach. The wireless communication can transmit speed up to 144 Kbps. It also can transmit control commands at a faster speed than the conventional infrared light. The transmission range also is greater and does not have control distance limitation.

To achieve the foregoing objects, the apparatus and method for controlling remote carrier of the invention includes a control end and a carrier. Transmission between the control end and the carrier may be a wireless network or a wireless communication network or both. Hence a fast transmission channel may be established for remote control and overcome the distance limitation between the control end and the carrier. In addition, feedback information may be transmitted to the control end through networks and sensors to facilitate monitoring judgement and fully achieve the instant control advantage.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional technique to control a carrier in a short distance.

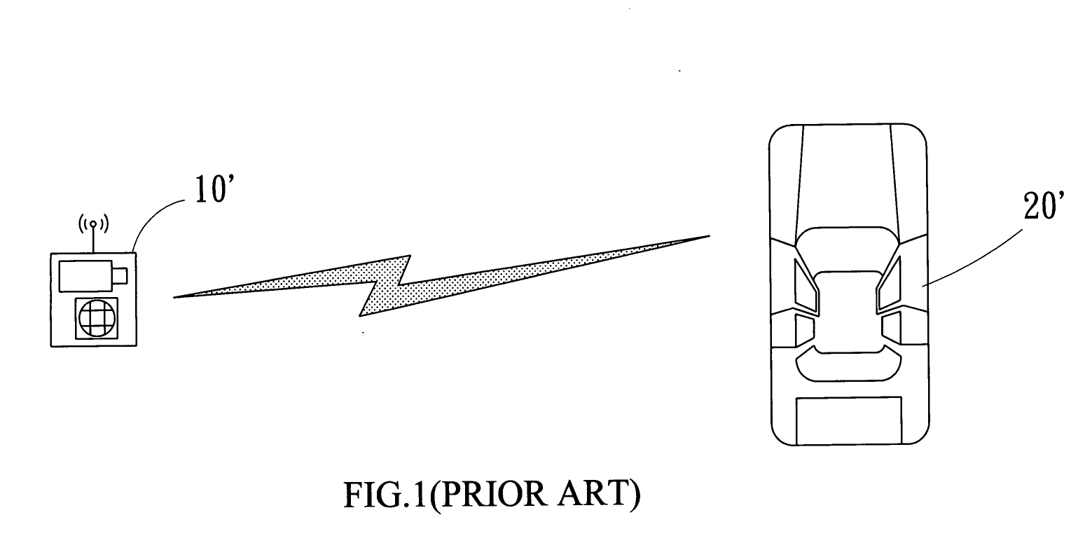

FIG. 2A is a process flow chart of a preferred embodiment of the present invention;

FIG. 2B is a process flow chart of another preferred embodiment of the present invention;

FIG. 3 is a block diagram of an apparatus in accordance with a preferred embodiment of the present invention; and

FIG. 4 is a functional block diagram of the embodiment of FIG. 3 of the present invention.

### DESCRIPTION OF THE PREFERRED EMBODIMENTS

The present invention aims to solve the problems of low transmission speed and limited transmission distance occurred to the conventional wireless or infrared transmission method. The invention provides a wireless network or a wireless communication network or both to increase transmission speed and extend control distance and instantly transmit information of the carrier end to the control end to correct and control the movement of the carrier.

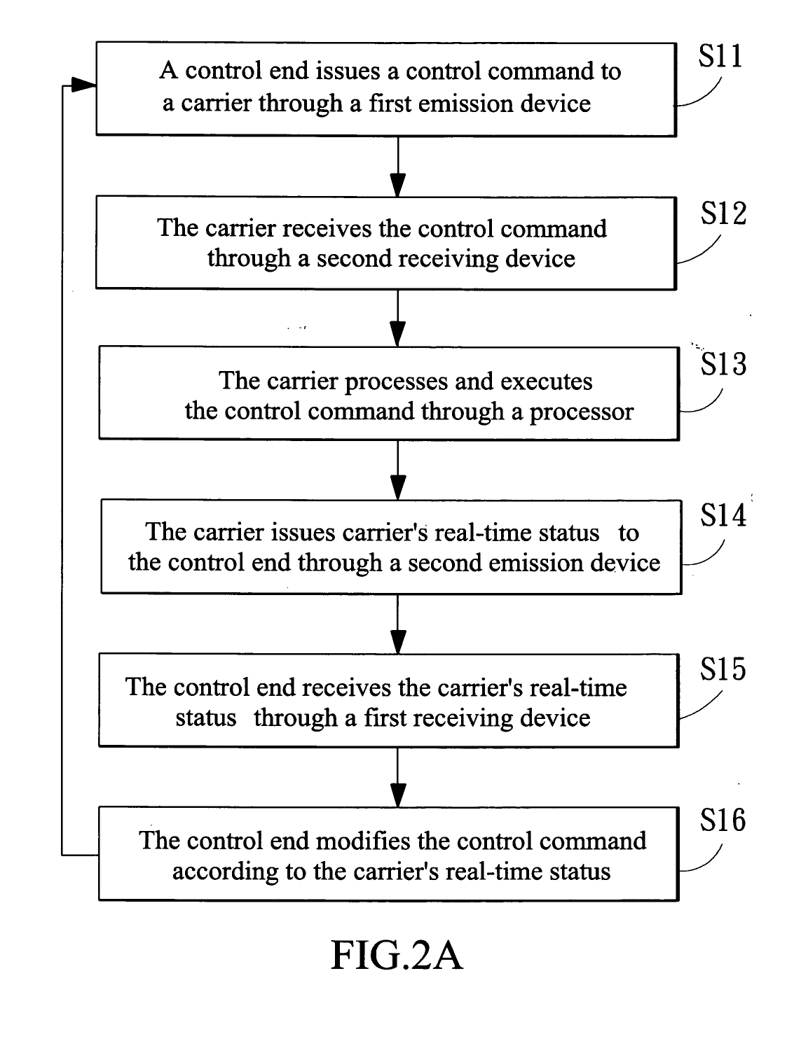

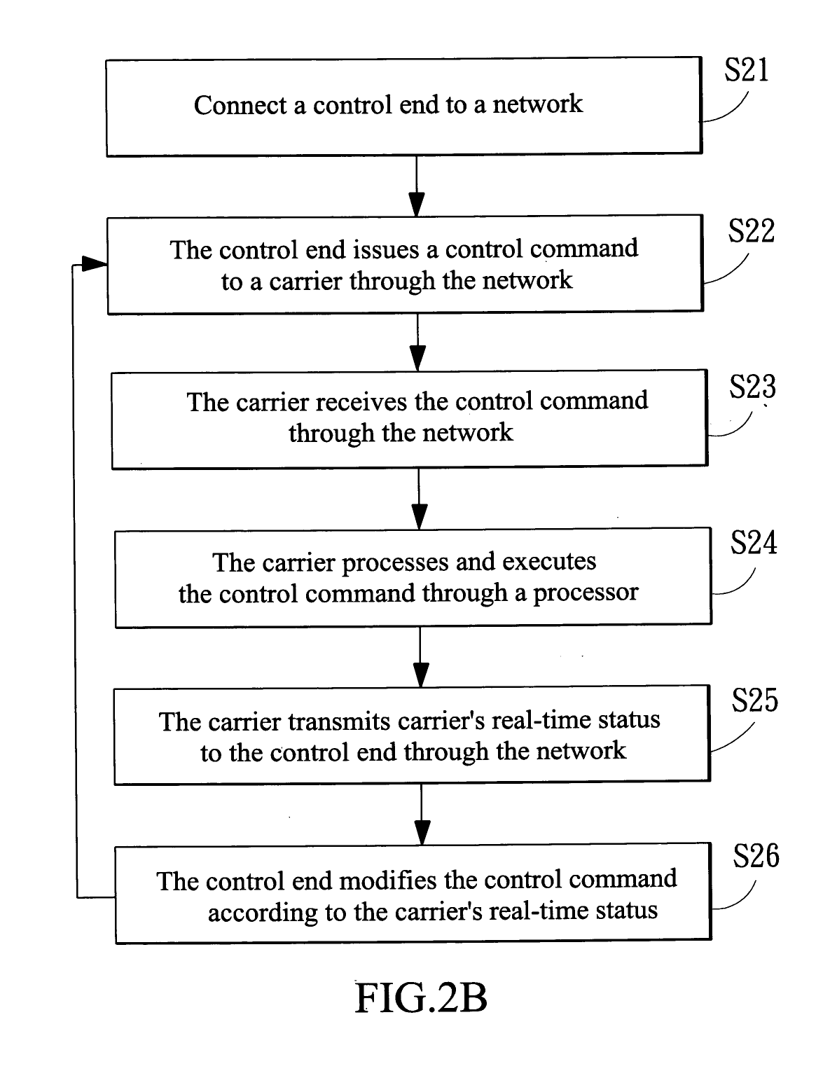

Refer to FIG. 2A for the process flow chart of an embodiment of the invention. The method for controlling remote carrier according to the invention is accomplished through wireless communication transmission. It includes steps as follow:

Step S11: a control end issues a control command to a carrier through a first emission device:

Step S12: the carrier receives the control command through a second receiving device;

Step S13: the carrier processes and executes the control command through a processor;

Step S14: the carrier issues a carrier's real-time status to the control end through a second emission device;

Step S15: the control end receives the carrier's real-time status through a first receiving device; and

Step S16: the control end modifies the control command according to the carrier's real-time status, and repeats Step S11.

Referring to FIG. 2B for the process flow chart of another embodiment of the invention. This embodiment controls remote carrier through wireless network transmission. It includes steps as follow:

Step S21: connect a control end to a network;

Step S22: the control end issues a control command to a carrier through the network;

Step S23: the carrier receives the control command through the network;

Step S24: the carrier processes and executes the control command through a processor;

Step S25: the carrier transmits a carrier's real-time status to the control end through the network; and

Step S26: the control end modifies the control command according to the carrier's real-time status and repeats Step S22.

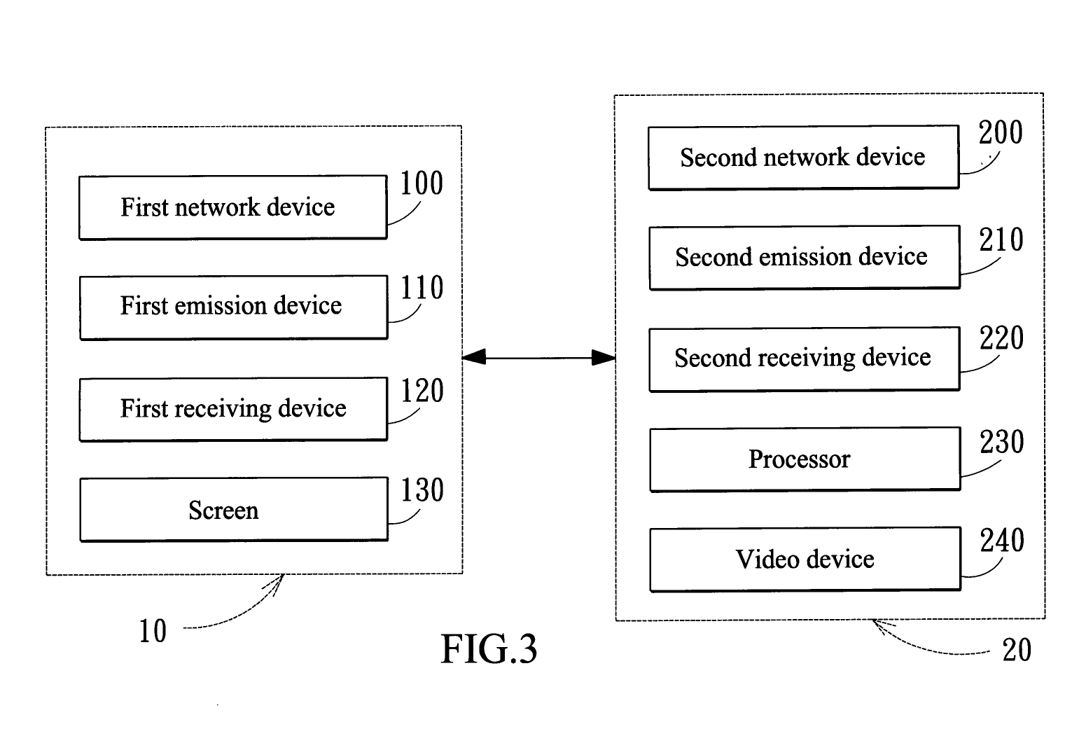

Refer to FIG. 3 for the block diagram of an apparatus in accordance with a preferred embodiment of the present invention. The apparatus according to the invention aims to control a remote carrier through network/wireless communication transmission. It mainly includes a control end 10 and a carrier 20 that can communicate with each other in a two-way fashion.

The control end 10 includes a first network device 100, a first emission device 110, a first receiving device 120 and a screen 130. The control end 10 may be a computer or personal digital assistant (PDA) equipped with the foregoing devices. It is to be noted that the control method may be accomplished through various types of computers, keyboards, mouse and other extended devices such as steering wheels, joystick, game pad.

The carrier 20 includes a second network device 200, a second emission device 210, a second receiving device 220, a processor 230 and a video device 240.

The control end 10 transmits a control command to the carrier 20; the processor 230 processes and executes the control command; and the video device 240 captures carrier's real-time status around the carrier 20 and transfers the status to the processor which processes the status and transmits back to the control end through a wireless network in packets. Thereby the control end 10 can monitor the status of the carrier 20 and update the control command by entering latest data through the control end 10, and transmit again to the carrier 20 through the wireless network.

The first network device 100 and the second network device 200 may be wired or wireless network devices. The carrier 10 is a device with self-generating power.

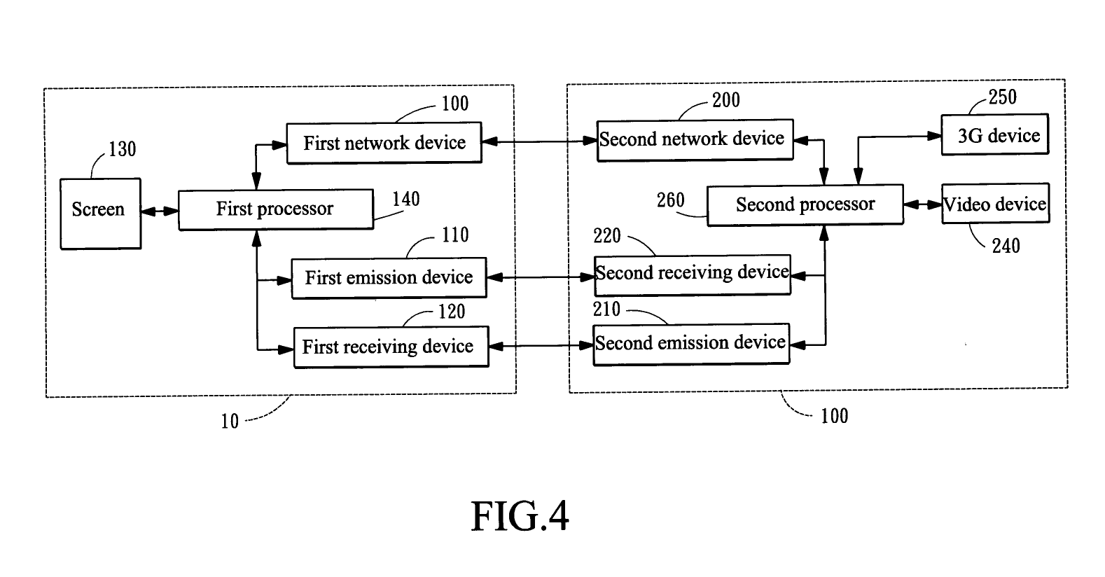

Refer to FIG. 4 for the functional block diagram of a preferred embodiment of FIG. 3 of the present invention. The control end 10 executes user's command through a first processor 140. The control command is transmitted through a first network device 100 or a first emission device 110. The carrier 20 receives the control command through a second network device 200 or a second receiving device 220. The received control command is processed and executed by a second processor 260 of the carrier 20. The carrier 20 has a video device 240 to capture carrier's real-time status, or positioning signals through a 3G (Global System for Mobile Communications GSM, General Packet Radio Service GPRS, Global Positioning System, GPS) device 250. Then the captured status or signals are transmitted to a first receiving device 120 or the first network device 100 of the control end 10 through a second emission device 210 or the second network device 200 of the carrier 20. Such a mechanism does not have control distance limitation. Moreover, the control end 10 and the carrier 20 can communicate with each other in a two-way communication to provide an on-site control feeling. In addition, either the control end 10 or the carrier 20 may be computerized. And according to requirements, the operating system (such as window operating system based) may include application programs such as identification, power on setting, electronic map, auto-piloting, information gathering, image recognition, data analysis, and the like to increase operation diversity and functions.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. An apparatus for controlling remote carrier transmitting control commands through network/wireless communication, comprising:
a control end including a first network device, a first emission device, a first receiving device and a screen; and
a carrier including a second network device, a second emission device, a second receiving device, a processor and a video device;
the control end transmits the control commands to the carrier that are processed by the processor of the carrier, the video device of the carrier capturing carrier's real-time status and transmitting to the control end to form a two-way communication mode.

2. The apparatus of claim 1, wherein the control end is a computer.

3. The apparatus of claim 1, wherein the control end is a personal digital assistant (PDA).

4. The apparatus of claim 1, wherein the control end can be extended devices.

5. The apparatus of claim 4, wherein the control end is a steering wheel.

6. The apparatus of claim 4, wherein the control end is a joystick.

7. The apparatus of claim 4, wherein the control end is a game pad.

8. The apparatus of claim 1, wherein the first network device and the second network device are wired network devices.

9. The apparatus of claim 1, wherein the first network device and the second network device are wireless network devices.

10. The apparatus of claim 1, wherein the carrier has self-generating power.

11. The apparatus of claim 1, wherein the carrier includes a 3G (Global System for Mobile Communications GSM, General Packet Radio Service GPRS, Global Positioning System, GPS) device.

12. The apparatus of claim 1, wherein the control end and the carrier using a window operating system based software.

13. An apparatus for controlling remote carrier transmitting control commands through a network, comprising:
a control end including a first network device and a screen; and
a carrier including a second network device, a processor and a video device;
the control end processes and executes the control commands through connection of the first network device and the second network device and the processor, the video device capturing carrier's real-time status and transmitting to the control end to form a dual-way communication mode.

14. The apparatus of claim 13, wherein the control end is a computer.

15. The apparatus of claim 13, wherein the control end is a personal digital assistant (PDA).

16. The apparatus of claim 13, wherein the first network device and the second network device are wired network devices.

17. The apparatus of claim 13, wherein the first network device and the second network device are wireless network devices.

18. An apparatus for controlling remote carrier transmitting control commands through wireless communication transmission, comprising:
a control end including a first emission device, a first receiving device and a screen; and
a carrier including a second emission device, a second receiving device, a processor and a video device;
the control end emits signals which contain the control commands through the first emission device, the second receiving device receiving the signals, the processor processing and executing the control commands, the video device capturing carrier's real-time status, and transmitting to the control end to form a dual-way communication mode.

19. The apparatus of claim 18, wherein the control end is a computer.

20. The apparatus of claim 18, wherein the control end is a personal digital assistant (PDA).

21. The apparatus of claim 18, wherein the carrier has self-generating power.

22. A method for controlling remote carrier through wireless communication transmission, comprising steps of:
issuing a control command from a first emission device of a control end to a carrier;
receiving the control command by a second receiving device of the carrier;
processing and executing the control command by a processor of the carrier;
issuing an carrier's real-time status from a second emission device of the carrier to the control end;
receiving the carrier's real-time status by a first receiving device of the control end; and
modifying the control command by the control end according to the carrier's real-time status and transmitting the modified control command to the carrier.

23. A method for controlling remote carrier through network transmission, comprising steps of:
connecting a control end to a network;
issuing a control command from the control end to a carrier through the network;
receiving the control command by the carrier through the network;
processing and executing the control command by a processor in the carrier;
issuing an carrier's real-time status from the carrier to the control end through the network; and
modifying the control command by the control end according to the carrier's real-time status and transmitting the modified control command to the carrier.
